(19) United States
(12) Patent Application Publication
(10) Pub. No.: US 2006/0083901 A1
(43) Pub. Date: Apr. 20, 2006

(54) Double sided tape for attaching plasma display panel and plasma display apparatus having the same

(75) Inventor: In-Soo Cho, Suwon-si (KR)

Correspondence Address: H.C. PARK & ASSOCIATES, PLC, 8500 LEESBURG PIKE, SUITE 7500, VIENNA, VA, 22182, US

(73) Assignee: Samsung SDI Co., Ltd.

(21) Appl. No.: 11/229,665

(22) Filed: Sep. 20, 2005

(30) Foreign Application Priority Data
Oct. 14, 2004 (KR) 10-2004-0082093

(51) Int. Cl. B32B 3/20

(52) U.S. Cl. 428/188; 428/174; 428/354

(57) ABSTRACT

Double sided tape for attaching a plasma display panel. The tape includes a first adhesive surface and a second adhesive surface opposing the first adhesive surface. The first and second adhesive surfaces respectively include a plurality of curved portions having valley portions extending in a width direction of the adhesive surface and convex portions protruding between the valley portions.

### CROSS-REFERENCE TO RELATED PATENT APPLICATIONS

This application claims priority to and the benefit of Korean Patent Application No. 10-2004-0082093, filed on Oct. 14, 2004, which is hereby incorporated by reference for all purposes as if fully set forth herein.

### BACKGROUND OF THE INVENTION

1. Field of the Invention

The present invention relates to a double sided tape for attaching a plasma display panel, and a plasma display apparatus having the same, and more particularly, to a double sided tape that may have improved adhesive force.

2. Discussion of the Background

Generally, a plasma display apparatus is a flat panel display that displays images using gas discharge, and it is highlighted as a substitute for the cathode ray tube (CRT) since it has excellent display characteristics such as screen size, brightness, contrast, residual image, and viewing angle. The plasma display apparatus includes a plasma display panel (PDP) having front and rear glass substrates, and a chassis base supporting the PDP.

FIG. 1 is a schematic perspective view of a supporting structure of a conventional PDP.

Referring to FIG. 1, the PDP 11 of the plasma display apparatus includes a front substrate 12 and a rear substrate 13, and a thermal conductive sheet 14 is attached to a rear surface of the rear substrate 13. A chassis base 15, which may be made of a metal such as aluminum, supports the PDP 11. The PDP 11 is attached to a front surface of the chassis base 15 using a double sided tape 16. Referring to FIG. 1, the double sided tape 16 extends in transverse and longitudinal directions at portions corresponding to gaps between the thermal conductive sheet 14. That is, the double sided tape 16 and the thermal conductive sheet 14 are arranged so that they do not overlap with each other. A fixing unit 15a, which is formed on an edge of the chassis base 15, couples the chassis base 15 with another member such as a case (not shown).

FIG. 2 is a cross-sectional view showing the conventional PDP and the supporting structure of FIG. 1 after assembly.

Referring to FIG. 2, the PDP 11 is attached onto a front surface of the chassis base 15 by the double sided tape 16. The thermal conductive sheet 14 is disposed between the PDP 11 and the front surface of the chassis base 15 to transmit heat generated by the PDP 11 to the chassis base 15.

FIG. 3 is a schematic perspective view of the double sided tape of FIG. 1 and FIG. 2.

Referring to FIG. 3, the double sided tape 16 has a substantially uniform thickness (t), and it includes a first adhesive surface 31 and a second adhesive surface (not shown) opposing the first adhesive surface (i.e. the bottom surface of the tape as shown in FIG. 3). The adhesive surfaces of the double sided tape 16 are substantially planar surfaces as shown in FIG. 3.

According to the supporting structure of the PDP described above, the double sided tape may not provide enough adhesive force between the plasma display panel 11 and the chassis base 15 to fix the plasma display panel 11 onto the chassis base 15. There may be many reasons for the adhesive force weakening, including that air may be induced into an adhesive surface of the double sided tape 16 when the PDP 11 is attached using the tape 16. The air induced into the attached surface of the double sided tape 16 is surrounded by the tape 16, and an air pore is formed. Additionally, since the air pore expands when the temperature rises, the double sided tape 16 may separate from the PDP 11 or the chassis base 15.

Further, the PDP 11 and the chassis base 15 are pressed toward each other in order to ensure sufficient attaching area when they are attached using the double sided tape 16. Here, the double sided tape 16 compresses as the PDP 11 and the chassis base 15 are pressed together. However, the amount that the double sided tape 16 may be compressed is limited. Therefore, the pressing force may not be increased sufficiently, and accordingly, the adhesive force may not be sufficient to strongly attach the PDP 11 and the chassis base 15.

### SUMMARY OF THE INVENTION

The present invention provides double sided tape for attaching a PDP that may provide improved adhesive force between the PDP and a chassis base, and a plasma display apparatus having the tape.

Additional features of the invention will be set forth in the description which follows, and in part will be apparent from the description, or may be learned by practice of the invention.

The present invention discloses a double sided tape for attaching a display panel. The tape includes a first adhesive surface and a second adhesive surface opposing the first adhesive surface. At least one of the first adhesive surface and the second adhesive surface comprises a curved surface.

The present invention also discloses a double sided tape for attaching a display panel and including a first adhesive surface, a second adhesive surface opposing the first adhesive surface, and a ventilation hole.

The present invention also discloses a plasma display apparatus including a front case and a back case coupled with the front case to form an inner space, a PDP arranged in the inner space and including a front substrate and a rear substrate, a chassis base supporting the PDP, and a double sided tape coupling the chassis base with the PDP. The double sided tape includes a first adhesive surface and a second adhesive surface opposing the first adhesive surface, and at least one of the first adhesive surface and the second adhesive surface has a curved surface.

The present invention also discloses a plasma display apparatus including a front case, a back case coupled with the front case to form an inner space, a PDP arranged in the inner space and including a front substrate and a rear substrate, a chassis base supporting the PDP, and double sided tape coupling the chassis base with the PDP. The double sided tape includes a first adhesive surface, a second adhesive surface opposing the first adhesive surface, and a ventilation hole.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic perspective view showing a conventional PDP supporting structure.

FIG. 2 is a cross-sectional view showing an assembled status of the PDP supporting structure of FIG. 1.

FIG. 3 is a schematic perspective view showing a double sided tape of FIG. 1 and FIG. 2.

FIG. 4 is a schematic perspective view showing a double sided tape for attaching a PDP according to an exemplary embodiment of the present invention.

FIG. 5 is a schematic perspective view showing a double sided tape for attaching the PDP according to another exemplary embodiment of the present invention.

FIG. 6 is a schematic perspective view showing double sided tape attached between the PDP and a chassis base according to an exemplary embodiment of the present invention.

FIG. 7 is a schematic perspective view showing a plasma display apparatus including double sided tape for attaching the PDP according to an exemplary embodiment of the present invention.

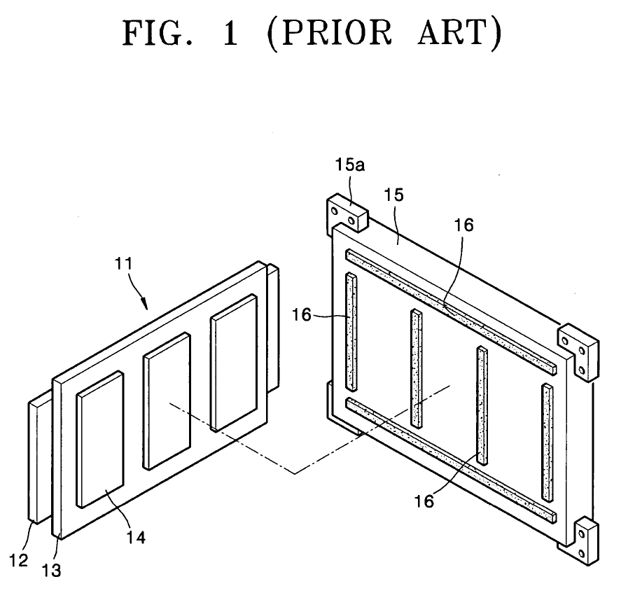

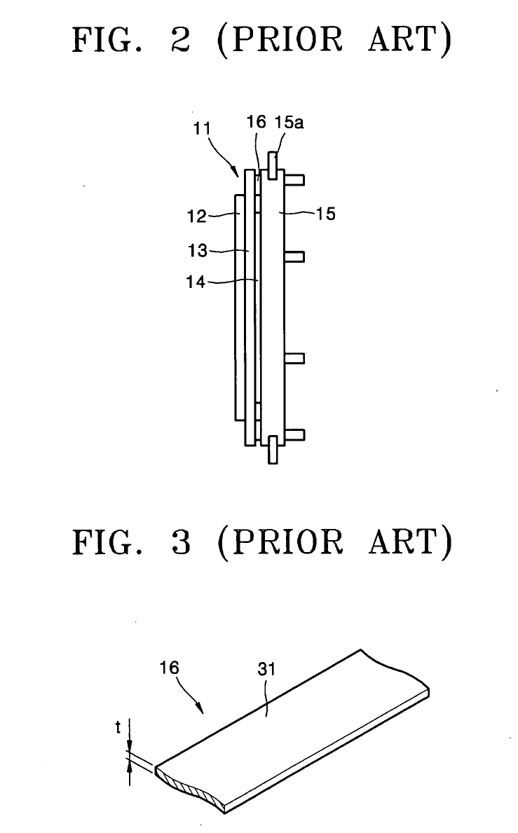

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of elements and regions may be exaggerated for clarity.

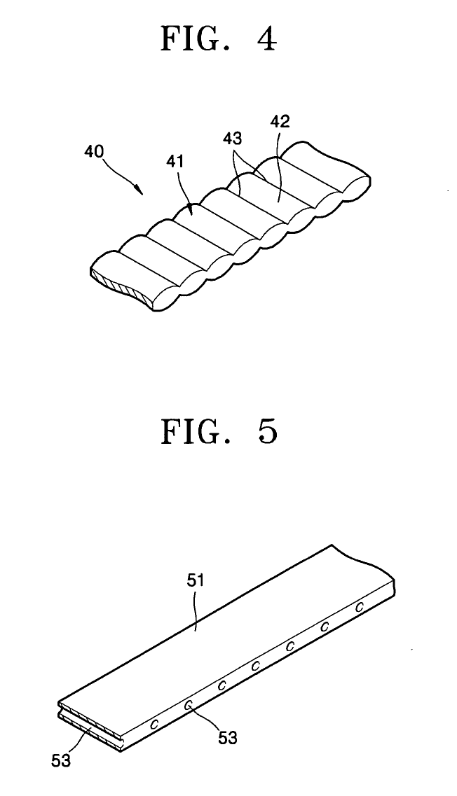

FIG. 4 is a schematic perspective view of a double sided tape for attaching a PDP according to an exemplary embodiment of the present invention.

Referring to FIG. 4, the double sided tape 40 includes a first adhesive surface 41 and a second adhesive surface (not shown) opposing the first adhesive surface 41 (i.e. the bottom surface of the tape 40). The first and second adhesive surfaces are curved surfaces. The curved surface of the first adhesive surface 41 includes valley portions 43 extending in a width direction of the double sided tape 40 and convex portions 42 protruding between the valley portions 43. The second adhesive surface may also comprise the valley portions 43 and the convex portions 42.

The valley portion 43 of the double sided tape 40 permits air to discharge when the PDP is attached using the double sided tape 40. That is, when a PDP and chassis base are pressed toward each other, the air existing on the surface of the double sided tape 40 may be exhausted through the valley portions 43. Additionally, since adhesive material is applied on the valley portions 43 as well as on the convex portions 42, the coupling of the PDP and chassis base may be made through both the convex portions 42 and the valley portions 43. That is, the valley portions 43 not only act as paths for exhausting air, they also serve to couple the PDP with the chassis base.

FIG. 4 shows the valley portions and convex protruded portions of the first adhesive surface 41 and the second adhesive surface corresponding to each other. In other words, the surfaces are substantially mirror images of each other. However, other arrangements are possible. For example, the valley portions of the first adhesive surface 41 and the convex protruded portions the second adhesive surface may be arranged corresponding to each other, and the valley portions of the second adhesive surface and the convex protruded portions of the first adhesive surface 41 may be arranged corresponding to each other.

FIG. 5 is a schematic perspective view of a double sided tape for attaching the PDP according to another exemplary embodiment of the present invention.

Referring to FIG. 5, the double sided tape 50 includes a first adhesive surface 51 and a second adhesive surface (not shown) opposing the first adhesive surface 51. The double sided tape 50 may be formed of porous materials. The double sided tape 50 includes a plurality of ventilation holes 53 that extend in the width direction of the double sided tape 50, thereby providing the double sided tape 50 with a buffering function. That is, when pressing the double sided tape 50, the thickness reduction ratio of the tape 50 increases due to the ventilation holes 53, such the thickness reduction ratio may significantly exceed that of conventional double sided tape, which does not have ventilation holes. The double sided tape 50 may be further compressed than conventional tape because air may be exhausted through its ventilation holes 53. When the pressure applied onto the double sided tape 50 is removed, the double sided tape 50 may return to its original thickness.

If the double sided tape 50 is used to couple a PDP with a chassis base, the pressure applied between the PDP and the chassis base may be increased when coupling the PDP and the chassis base together. That is, the double sided tape 50 may endure the externally applied pressure by reducing its thickness. Hence, the double sided tape 50 may be attached onto the PDP and the chassis base more strongly than conventional tape. Therefore, the adhesive force may be increased, thereby providing sufficient adhesive force for coupling the PDP with the chassis base. Although not shown in FIG. 4, ventilation holes, which are similar to the ventilation holes 53 of FIG. 5, may be formed extending in a width direction of the double sided tape 40. For example, the ventilation holes may extend in the width direction of the double sided tape 40 at a location corresponding to the convex protruded portions of the first adhesive surface 41 and the second adhesive surface.

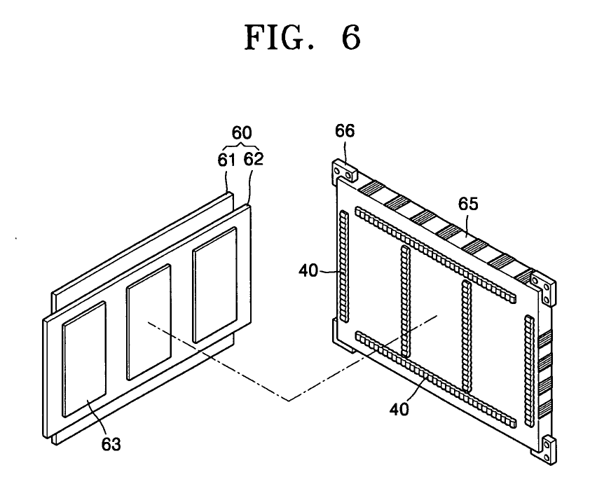

FIG. 6 is a schematic perspective view showing double sided tape attached between a PDP and a chassis base according to an exemplary embodiment of the present invention.

Referring to FIG. 6, the PDP 60 includes a front substrate 61 and a rear substrate 62, and a thermal conductive sheet 63 is attached on a back surface of the rear substrate 62. The double sided tape 40 is arranged between the PDP's rear substrate 62 and the chassis base 65 so that the thermal conductive sheet 63 and the tape 40 do not overlap with each other. As described above, when the PDP 60 is pressed toward the chassis base 65, air may be exhausted through the valley portions 43 (refer to FIG. 4) formed on the double sided tape 40. Reference numeral 66 denotes a fixing unit.

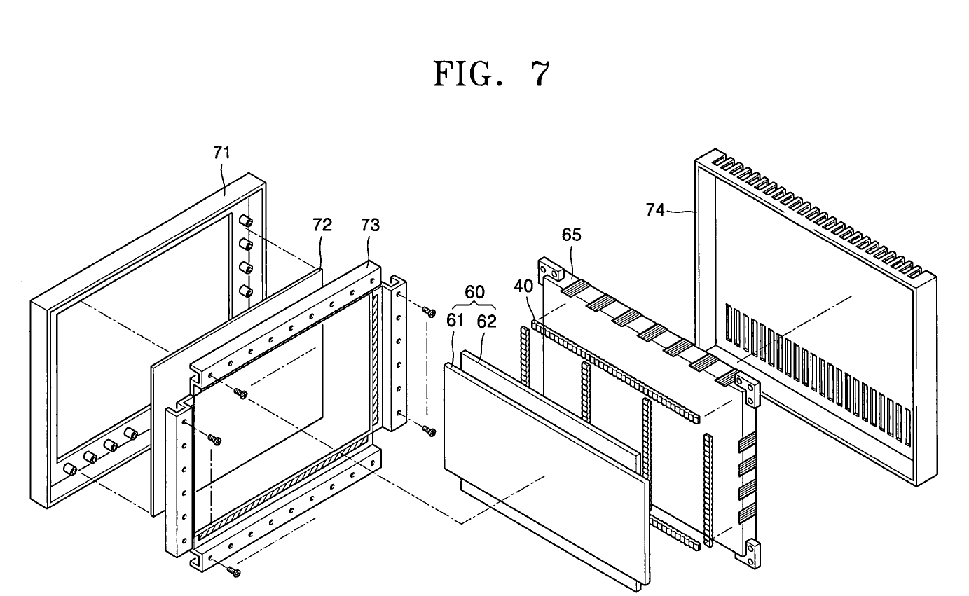

FIG. 7 is a schematic perspective view showing a plasma display apparatus including the double sided tape for attaching the PDP according to an exemplary embodiment of the present invention.

Referring to FIG. 7, the plasma display apparatus includes a front case 71 including a window, a back case 74 coupled with the front case 71 to form an inner space, a filter holder 73 installed in the inner space, a filter 72 maintained by the filter holder 73 and exposed through the window of the front case 71, the PDP 60 arranged behind the filter 72 and including the front substrate 61 and the rear substrate 62, the chassis base 65 coupled with the PDP 60, and the double sided tape 40 for coupling the PDP 60 with the chassis base 65. The double sided tape used to couple the PDP 60 with the chassis base is double sided tape according to an embodiment of the present invention, such as the double sided tape 40 of FIG. 4, which includes the valley portions 43 and the convex portions 42, or the double sided tape 50 of FIG. 5, which includes the ventilation holes 53. Although it is not shown in the drawings, a printed circuit board may be installed on a back surface of the chassis base 65, and a plurality of electronic elements (not shown) are installed on the printed circuit board to drive the PDP 60.

According to embodiments of the present invention, the PDP may be sufficiently coupled with the chassis base using double sided tape, and the pressure applied to attach the PDP onto the chassis base may be increased. Therefore, the PDP may not separate from the chassis base under severe conditions, such as increasing temperature in the apparatus, due to the strengthened adhesive force. Additionally, it is possible to prevent shortening of the PDP's life span due to weakened adhesive force over time.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A double sided tape for attaching a display panel, comprising:
a first adhesive surface; and
a second adhesive surface opposing the first adhesive surface,
wherein at least one of the first adhesive surface and the second adhesive surface comprises a curved surface.

2. The double sided tape of claim 1, wherein both the first adhesive surface and the second adhesive surface comprise the curved surface.

3. The double sided tape of claim 1, wherein the first adhesive surface comprises a valley portion and a convex protruded portion, the convex protruded portion being arranged between adjacent valley portions.

4. The double sided tape of claim 3, wherein the second adhesive surface comprises a valley portion and a convex protruded portion, the convex protruded portion being arranged between adjacent valley portions.

5. The double sided tape of claim 4, wherein valley portions and convex protruded portions of the first adhesive surface and the second adhesive surface are arranged corresponding to each other.

6. The double sided tape of claim 4, wherein valley portions of the first adhesive surface and convex protruded portions the second adhesive surface are arranged corresponding to each other, and valley portions of the second adhesive surface and convex protruded portions of the first adhesive surface are arranged corresponding to each other.

7. The double sided tape of claim 1, further comprising:
a ventilation hole,
wherein the ventilation hole extends in a width direction of the double sided tape.

8. The double sided tape of claim 5, further comprising:
a ventilation hole,
wherein the ventilation hole extends in a width direction of the double sided tape at a location corresponding to the convex protruded portions of the first adhesive surface and the second adhesive surface.

9. The double sided tape of claim 1, wherein the display panel is a plasma display panel.

10. A double sided tape for attaching a display panel, comprising:
a first adhesive surface;
a second adhesive surface opposing the first adhesive surface; and
a ventilation hole.

11. The double sided tape of claim 10, wherein the ventilation hole extends in a width direction of the double sided tape.

12. The double sided tape of claim 11, wherein the display panel is a plasma display panel.

13. A plasma display apparatus, comprising:
a front case;
a back case coupled with the front case to form an inner space;
a plasma display panel arranged in the inner space and including a front substrate and a rear substrate;
a chassis base supporting the plasma display panel; and
double sided tape coupling the chassis base with the plasma display panel,
wherein the double sided tape comprises a first adhesive surface and a second adhesive surface opposing the first adhesive surface, at least one of the first adhesive surface and the second adhesive surface comprising a curved surface.

14. The plasma display apparatus of claim 13, wherein both the first adhesive surface and the second adhesive surface comprise the curved surface.

15. The plasma display apparatus of claim 13, wherein the first adhesive surface comprises a valley portion and a convex protruded portion, the convex protruded portion being arranged between adjacent valley portions.

16. The plasma display apparatus of claim 15, wherein the second adhesive surface comprises a valley portion and a convex protruded portion, the convex protruded portion being arranged between adjacent valley portions.

17. The plasma display apparatus of claim 15, wherein the double sided tape is attached between the rear substrate and the chassis base.

18. A plasma display apparatus, comprising:
a front case;
a back case coupled with the front case to form an inner space;
a plasma display panel arranged in the inner space and including a front substrate and a rear substrate;
a chassis base supporting the plasma display panel; and
double sided tape coupling the chassis base with the plasma display panel,
wherein the double sided tape comprises a first adhesive surface, a second adhesive surface opposing the first adhesive surface, and a ventilation hole.

19. The plasma display apparatus of claim 18, wherein the ventilation hole extends in a width direction of the double sided tape.

20. The plasma display apparatus of claim 19, wherein the double sided tape is attached between the rear substrate and the chassis base
